(19) United States
(12) Patent Application Publication
(10) Pub. No.: US 2026/0017695 A1
(43) Pub. Date: Jan. 15, 2026

(54) COMPUTER-BASED METHOD FOR INITIATING COMMUNICATION WITH A PROSPECTIVE CUSTOMER, AND COMMUNICATIONS SYSTEM

(71) Applicant: CHEP Technology Pty Limited, Sydney (AU)

(72) Inventor: Marco PANNICKE, Cologne (DE)

(21) Appl. No.: 19/271,491

(22) Filed: Jul. 16, 2025

Related U.S. Application Data
(63) Continuation of application No. 17/268,646, filed on Feb. 16, 2021, now Pat. No. 12,387,245.

(30) Foreign Application Priority Data
Aug. 17, 2018 (DE) 102018120076.5

(51) Int. Cl. G06Q 30/02; G06Q 30/015; G06Q 30/0601; H04L 51/02

(52) U.S. Cl. CPC G06Q 30/0281; G06Q 30/015; G06Q 30/0641; H04L 51/02

(57) ABSTRACT

A computer-based method for initiating communication with a prospective customer by means of a beacon installed on a shop floor is disclosed. The following steps are provided: detecting that a smart device is approaching the beacon; transmitting a chat invitation signal to the smart device; receiving a chat confirmation signal; and launching a chat on the smart device, in particular with a chatbot. A communications system and a computer program are also proposed.

### CROSS-REFERENCE TO RELATED APPLICATIONS

This application is a continuation of U.S. patent application Ser. No. 17/268,646, filed Feb. 16, 2021, which is a National Stage Entry of PCT Application No. PCT/EP2019/072060, filed Aug. 16, 2019, which claims priority to German Patent Application No. DE102018120076, filed Aug. 17, 2018, the contents of each of which are hereby incorporated by reference in its entirety.

### DESCRIPTION

The invention relates to a computer-based method for initiating communication with a prospective customer by means of a beacon installed on a shop floor.

It is known from the prior art that “beacons” operating using the Bluetooth standard are used on shop floors, for example in a supermarket. The signals of the beacons can be received by smartphones. As a result, when a prospective customer is in the vicinity of the beacon, they can be sent a notification, for example a notice about a special offer on certain products. In particular, the beacon can be located on a product pallet loaded with said products. When the product pallet is located on a shop floor, the beacon is installed on the shop floor.

One disadvantage of the manner in which a notification is transmitted in the prior art is that the transmission is possible only when the prospective customer has a particular app installed on their smartphone, for example the customer loyalty app of the supermarket chain in whose branch the prospective customer is currently located, or a bonus app covering various supermarket chains.

The object of the invention is to make the prospective customer aware of particular products or services without the customer needing to have the “appropriate” app installed on their smartphone.

To achieve this object, the following steps are provided according to the invention:
detecting that a smart device is approaching the beacon;
transmitting a chat invitation signal to the smart device;
receiving a chat confirmation signal; and
launching a chat on the smart device, in particular with a chatbot.

The advantage of this method is that a special, supermarket-specific app is not required, but rather the chat is launched in a standard instant messaging app installed on practically every smart device, in particular practically every smartphone. Examples of such instant messaging apps are the Facebook app and WhatsApp.

A particular advantage of the method is that the prospective customer need not log into a website.

The beacon is preferably arranged on a product pallet and linked to the goods loaded thereon, such that the prospective customer can be “spoken to” at the correct time, namely when they are located in the vicinity of the products, regardless of the position of the product pallet on the shop floor.

The notification displayed on the smartphone can indicate to the user that it is possible to chat with an employee, an advisor or customer service such that any questions from the prospective customer can be answered in an automated manner, additional information can be given or an offer customised for them can be provided.

The method according to the invention may proceed as follows:

Various product pallets equipped with beacons are located on a shop floor of a supermarket. Said beacons broadcast product-specific information.

The signals of the beacons can be received by the smartphone of a prospective customer, provided that the smartphone accepts push notifications via Bluetooth and has location services activated.

When a prospective customer reaches the vicinity of a particular product pallet together with their smartphone, a notification is displayed on the smartphone stating that it is possible to chat directly with an employee, customer service or a customer advisor.

If the prospective customer clicks on the notification, a connection to a chatbot is launched in an instant messaging app. This makes it possible to give the prospective customer additional (promotional) information on the products, to provide them with an offer specially customised for them or even to show them product information dynamically depending on the particular location, at which time the prospective customer can give direct feedback.

According to the invention, the object is also achieved by a communications system comprising a beacon that is installed on a shop floor and configured to detect (or “communicate” with) an approaching smart device and broadcast a chat invitation signal to the smart device, and comprising a controller that is connected to the beacon for signal transmission and is configured to carry out an above-described method. As regards the advantages, reference is made to the above explanations. In other words, the beacon is thus configured to communicate with the smart device.

For example, by means of the chat invitation signal, a Universally Unique Identifier (UUID) can be broadcast to the smart device.

The beacon is preferably arranged on a product pallet.

The controller can be integrated in the beacon and/or be part of a separate data processing unit. The separate data processing unit is, for example, a computer, a laptop, a notebook computer, a smartphone or another smart device.

The controller can also be connected, for signal transmission, to a plurality of beacons distributed, for example, over a relatively large shop floor. The various beacons can then be controlled centrally by the separate data processing unit.

According to the invention, the object is also achieved by a computer program comprising program code means for carrying out an above-described method when the computer program is executed on a computer and/or a controller, in particular on a controller of an above-described communications system.

Further advantages and features of the invention will become apparent from the following description and the drawings, to which reference is made and in which:

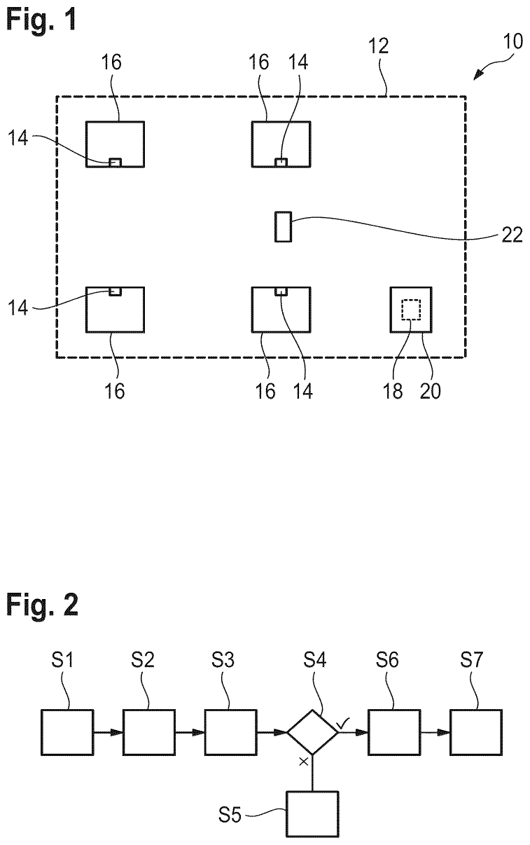

FIG. 1 is a schematic plan view of a communications system according to the invention; and

FIG. 2 is a schematic flow chart of the steps of a method according to the invention.

FIG. 1 schematically shows a communications system 10. The communications system comprises a plurality of beacons 14 arranged on a shop floor 12, the beacons 14 each being attached to a product pallet 16.

The beacons 14 are wirelessly connected to a controller 18 for signal transmission, said controller being arranged in a separate, central computer 20. Alternatively, the controller can also be housed in one of the beacons 14.

The controller 18 is configured to carry out a method for initiating communication with a prospective customer, as described below on the basis of FIG. 2. In particular, a computer program comprising program code means for carrying out the method runs on the controller.

First, it is detected by means of at least one beacon 14 that a smart device 22 is approaching the at least one beacon 14 (step S1). In particular, the smart device 22 is a smartphone.

The beacon 14 then broadcasts a chat invitation notification to the smart device 22 (step S2) and a corresponding notification is displayed to the user (step S3).

In particular, it is displayed to the user that it is possible to chat directly with an employee, customer service or a customer advisor.

The user can now either confirm or reject this chat invitation (step S4). If the user rejects the chat invitation, the communication with the smart device 22 is terminated (step S5).

However, if the user accepts the chat invitation, a chat confirmation signal from the smart device 22 is received by means of the beacon 14 (step S6) and a chat is launched on the smart device 22 (step S7), in particular with a chatbot.

In this case, the chat is launched in an instant messaging app already installed on the smart device. This makes it possible to give the prospective customer additional (promotional) information on the products, to give them an offer specially customised for them or even to show them product information dynamically depending on the particular location (i.e. depending on which of the beacons 14 they are located in the vicinity of), at which time the prospective customer can give direct feedback.

1-10. (canceled)

11. A method for initiating communication with a smart device carried by a prospective customer on a shop floor, the method comprising the following steps:
detecting that the smart device is approaching a beacon installed on the shop floor;
transmitting a chat invitation signal to the smart device;
receiving a chat confirmation signal from the smart device; and
launching a chat with a chatbot on the smart device.

12. The method according to claim 11, wherein the beacon is carried by a product pallet.

13. The method according to claim 11, further comprising displaying a notification on the smart device stating that it is possible to chat with an employee, an advisor, or customer service.

14. The method according to claim 11, wherein the chat is launched in an instant messaging app on the smart device.

15. The method according to claim 14, wherein the instant messaging app is installed on the smart device.

16. The method according to claim 11, wherein the beacon is one of a plurality of beacons, wherein each beacon is arranged on a respective product pallet.

17. The method according to claim 16, wherein each product pallet is selectively movable to different positions on the shop floor.

18. The method according to claim 16, further comprising:
displaying product information relating to a product on the product pallet, wherein the product information is dynamically displayed depending on which beacon of the plurality of beacons the smart device is in the vicinity of.

19. The method according to claim 18, further comprising receiving feedback via the chatbot on the smart device regarding the product information.

20. The method according to claim 18, wherein the chat is launched in an instant messaging app on the smart device, and wherein the product information is displayed via the instant messaging app.

21. The method according to claim 16, further comprising:
providing a customized offer via the chatbot on the smart device, wherein the customized offer is provided dynamically depending on which beacon of the plurality of beacons the smart device is in the vicinity of.

22. The method according to claim 21, further comprising receiving feedback via the chatbot on the smart device regarding the customized offer.

23. The method according to claim 21, wherein the chat is launched in an instant messaging app on the smart device, and wherein the customized offer is provided via the instant messaging app.

24. The method according to claim 11, wherein the chat invitation signal is transmitted by the beacon.

25. A communications system comprising:
a beacon installed on a shop floor and configured to detect an approaching smart device; and
a controller coupled to the beacon for signal transmission and is configured to perform the following:
transmit a chat invitation signal to the smart device;
receive a chat confirmation signal from the smart device; and
launch a chat with a chatbot on the smart device.

26. The communications system according to claim 25, wherein the beacon is carried by a product pallet.

27. The communications system according to claim 25, wherein the controller is carried by the beacon.

28. The communications system according to claim 25, wherein the controller is carried by a data processing unit separate from the beacon.

29. The communications system according to claim 25, wherein the communications system comprises a plurality of beacons installed on the shop floor, the plurality of beacons including the beacon, wherein each of the plurality of beacons is configured to detect an approaching smart device.

30. A non-transitory computer readable medium for operating a communications system, and with the non-transitory computer readable medium having a plurality of computer executable instructions for causing the communications system to perform steps comprising:
operating a beacon installed on a shop floor to detect an approaching smart device; and
operating a controller coupled to the beacon for signal transmission to perform the following:
transmit a chat invitation signal to the smart device,
receive a chat confirmation signal from the smart device, and
launch a chat with a chatbot on the smart device.
